(19) United States
(12) Patent Application Publication
(10) Pub. No.: US 2022/0389730 A1
(43) Pub. Date: Dec. 8, 2022

(54) FILTER EXTRACTION SYSTEMS AND TECHNIQUES PRINCIPALLY FOR AUTONOMOUS SWIMMING POOL CLEANERS

(71) Applicant: ZODIAC POOL CARE EUROPE, BELBERAUD (FR)

(72) Inventors: Louis Favie, Colomiers (FR); Simon Duffaut, Castelginest (FR); Remi Deloche, Toulouse (FR)

(73) Assignee: ZODIAC POOL CARE EUROPE, BELBERAUD (FR)

(21) Appl. No.: 17/741,198

(22) Filed: May 10, 2022

Related U.S. Application Data
(60) Provisional application No. 63/197,748, filed on Jun. 7, 2021.

(51) Int. Cl. E04H 4/16; G05D 1/02

(52) U.S. Cl. CPC E04H 4/1654; G05D 1/0206

(57) ABSTRACT

Automatic swimming pool cleaners (APCs) may include debris filters accessible from externally of the swimming pools in which the APCs are operating. The APCs may be programmed to climb to waterlines of the pools and present their debris filters above the waterlines for removal by users positioned outside the pools. Sensors may determine whether the filters have been reinstalled within the APCs, thus allowing the APCs to return to cleaning service.

### REFERENCE TO RELATED APPLICATION

This application claims the benefit of U.S. Provisional Patent Application No. 63/197,748, filed on Jun. 7, 2021 and entitled FILTER EXTRACTION SYSTEMS AND TECHNIQUES PRINCIPALLY FOR AUTONOMOUS SWIMMING POOL CLEANERS, the content of which is hereby incorporated by reference in its entirety.

### FIELD OF THE INVENTION

This invention relates to automatic swimming pool cleaners (APCs) and more particularly, although not necessarily exclusively, to systems and techniques for presenting filters of the APCs to users of the cleaners without requiring removal of the entireties of the cleaners from pools.

### BACKGROUND OF THE INVENTION

APCs often are hydraulic or robotic in type, with hydraulic cleaners varying water flow for movement and robotic cleaners usually employing electric motors to cause motion. Robotic cleaners, especially, are designed to move autonomously within pools and vacuum debris-laden water into on-board filters. Commonly owned U.S. Patent Application Publication No. 2021/0032888 of Lancry, et al., whose entire contents are incorporated herein by this reference, details an exemplary robotic APC useful to clean water of a swimming pool. In use, a pump on-board the APC operates to draw pool water into the cleaner, where the water passes through the filter (so as to trap debris entrained in the flowing water) before exiting to return to the pool. Conventionally, when the on-board filters are full, the APCs must be withdrawn from pools so users may access the filters and clean them of debris.

However, also detailed in the Lancry application is that bodies of its APCs “may be oriented at pool waterlines so as to make their on-board filters readily accessible for removal.” See id., Abstract, 11. 4-5. As further described therein:
Such easy removal, furthermore, may occur while a cleaner remains in a pool. Particularly beneficial is that the cleaner may present itself at the pool waterline in a manner allowing its filter to be grasped readily by someone positioned on a deck surrounding the pool.

### See id., p. ¶ 0010.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an APC may be configured to identify and climb a particular wall of a swimming pool to the waterline of the pool to facilitate removal of a debris filter of the APC.

According to some embodiments, an APC may be configured to maintain its position at a waterline of a swimming pool in both a first condition, when a debris filter is installed in a body of the APC, and in a second condition, when the debris filter is removed from the body of the APC.

According to various embodiments, an APC may be configured so that a user can remove a debris filter from a body of the APC without contacting water in the swimming pool in which the APC is operating.

According to some embodiments, an APC may be configured so that a user can install a debris filter into a body of the APC without contacting water in the swimming pool in which the APC is operating.

According to various embodiments, an APC may be configured to detect whether a debris filter has been installed into its body.

According to certain embodiments, an APC includes means for removably retaining a debris filter in position within a body of the APC, with such means being or comprising a latch, a magnet assembly, or underpressure, as examples.

According to various embodiments, an APC includes a spring or repulsive magnet to facilitate removing a debris filter from a body of the APC.

According to certain embodiments, an APC includes a debris filter having a handle, which also functions as a handle of the APC.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an APC at a waterline of a pool and with a filter of the APC stowed according to embodiments.

FIG. 2 illustrates the APC of FIG. 1 with the filter extracted from the APC according to embodiments.

### DESCRIPTION OF THE INVENTION

Described herein are systems and techniques facilitating access to on-board filters without requiring removal of APCs from pools. The APCs may include debris filters accessible from externally of the swimming pools in which the APCs are operating. The APCs may be programmed to climb to waterlines of the pools and present their debris filters above the waterlines for removal by users positioned outside the pools. Sensors may determine whether the filters have been reinstalled within the APCs, thus allowing the APCs to return to cleaning service.

The APCs may include various features for facilitating removal and/or retention of the filter on/within the APCs. In some embodiments, the APCs include a holding feature such as a latch, magnet, and/or pressurization, among others, for holding the filter. The APCs may include an ejecting feature such as a spring or repulsive magnet, among others, to facilitate removal of the filter from the APCs. In certain embodiments, the APCs may detect a presence or absence of the filter, and the APCs optionally may automatically perform an action based on a sensed removal and replacement of the filter within the APC. In various embodiments, the filter includes features facilitating handling by a user. As non-limiting examples, the filter may include a handle that can be used as a cleaner handle (e.g., for lifting the APC) and/or the filter may include a transparent or translucent cover such that a user can visually see debris within the filter. Various other benefits and advantages may be realized with the systems and methods provided herein, and the aforementioned advantages should not be considered limiting.

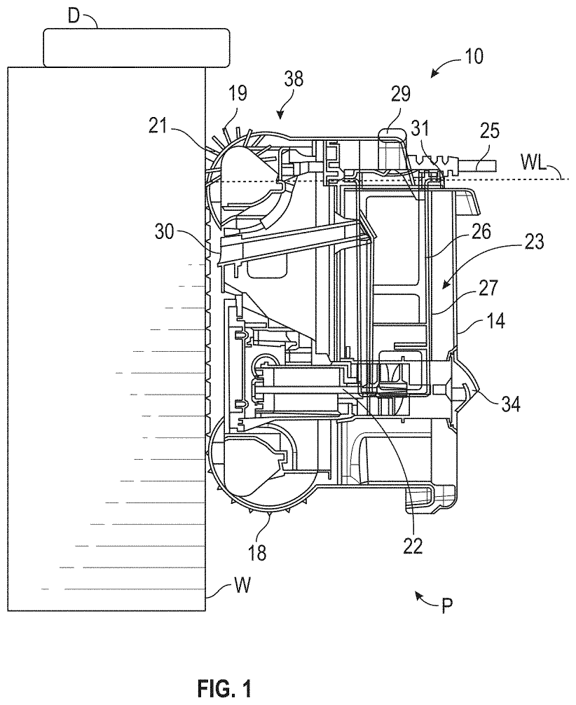

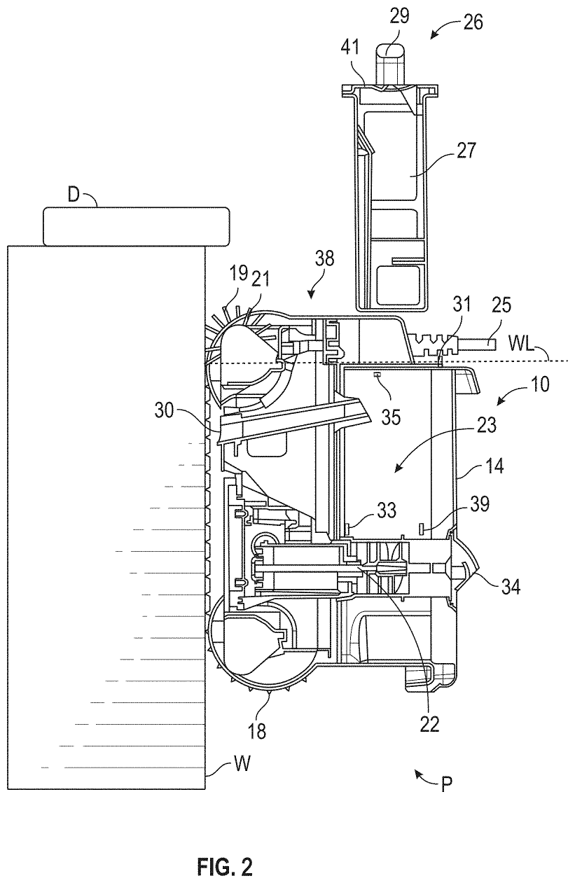

FIGS. 1 and 2 illustrate an exemplary APC 10 with a filter 26 according to embodiments of the invention. The APC 10 is illustrated as a robotic APC; however, the APC 10 illustrated should not be considered limiting as the filters 26 described herein may be used with other types of APCs and/or other types of APCs with fewer, additional, or various other combinations of features as desired.

As illustrated in FIGS. 1 and 2, the APC 10 includes a body 14, motive elements 18, a cleaning device 19 such as a brush assembly 21, a pump 22, and any suitable electric or other motors. Additionally or alternatively, the APC 10 optionally may include one or more of a controller (e.g., processor and/or memory), communication modules (e.g., facilitating wired and/or wireless communication to and/or from the APC 10, such as with an antenna 25), and an on-board power source such as rechargeable batteries. Under influence of the pump 22, debris-laden water may enter the body 14 of the APC 10 through one or more inlets 30 and pass through the filter 26 before exiting the body 14 through one or more outlets 34.

The body 14 of the APC 10 may define a front end 38, which forms a leading portion of the APC 10 as the APC 10 travels in a nominally forward direction. In some embodiments, the cleaning device 19 may be provided at or proximate to the front end 38, although it need not be in other embodiments. The body 14 generally defines a housing area 23, and one or more components of the APC 10 (e.g., motor block, pump 22, filter 26, etc.) may be at least partially housed within the housing area 23 when the APC 10 is assembled.

As best illustrated in FIG. 2, the filter 26 includes a filter body 27 and optionally includes a handle 29. Optionally, the filter 26 may include a transparent or translucent cover 41 (see FIG. 2), which may allow users to see debris trapped therein. However, in other embodiments, the filter 26 need not include a transparent or translucent cover.

As illustrated in FIGS. 1 and 2, the filter 26 may be accessible at the front end 38 such that the filter 26 may be selectively stowed (FIG. 1) or extracted (FIG. 2) at the front end 38. In certain embodiments, and as illustrated in FIG. 1, the filter body 27 may be at least partially positioned within the housing area 23 when stowed such that water from the pool P may enter through the one or more inlets 30, pass through the filter 26, and exit through the one or more outlets 34. When stowed, the handle 29 may be accessible outside of the housing area 23 such that a user may grab the handle 29 and optionally use the handle 29 as a cleaner handle (i.e., one that can be used to move the entire APC 10 and not just the filter 26). The APC 10 with filter 26 accessible at the front end 38 may facilitate removal of the filter 26 from the body 14. As an example, if the APC 10 presents itself at waterline WL of pool P (FIG. 1), the filter 26 is readily accessible to someone positioned on a surface or deck D surrounding the pool P and can be removed from the APC 10 (FIG. 2).

In certain embodiments, the APC 10 optionally includes a holding feature or means for removably retaining filter 26 within body 14 of the APC 10. In some versions of the APC 10, the holding feature or means may be a latch assembly 31 or magnet assembly may be employed to retain filter 26 in its useful position. Alternatively, the holding feature or means may include the pump 22, which may subject filter 26 to underpressure in order to retain the filter 26 in place. Persons skilled in the relevant field will recognize that other manners of removably retaining filter 26 in position may be utilized additionally or alternatively. The holding feature or means allows the handle 29 to function as a lifting handle that can be used to move the entire APC 10 when the holding feature/means is engaged to retain the filter 26 within the body 14 of the APC 10.

In various embodiments, the APC 10 optionally includes an ejecting feature or means for facilitating extraction of the filter 26 from the body. The ejecting feature may be various suitable devices or mechanisms as desired, including but not limited to a repulsive magnet 33 (see FIG. 2), a spring or other biasing mechanism, combinations thereof, and/or other features or combinations of features as desired. As one non-limiting example, the ejecting feature is the repulsive magnet 33 that may be activated (e.g., via an activation signal and/or by releasing the holding feature) such that the repulsive magnet 33 exerts a magnetic force on the debris filter 26 causing the debris filter 26 to move through the front end 38 (e.g., without necessarily requiring a pulling force by the user). As another non-limiting example, the ejecting feature is a spring or other biasing member that is compressed when the debris filter is in the APC 10 (e.g., FIG. 1). Upon activation (e.g., active activation or by releasing the holding feature), the spring may expand, thereby exerting a mechanical force of the debris filter 26 causing the debris filter 26 to move through and/or away from the front end 38. As mentioned, other ejecting features or techniques may be utilized as desired.

In some embodiments, the APC 10 optionally includes means or devices for determining when the filter 26 has been cleaned and/or re-installed in the body 14. In certain embodiments, the APC 10 includes a filter sensor 35 (see FIG. 2) for detecting the filter 26. Such a filter sensor 25 may be various types of sensors as desired suitable for detecting a presence and/or a cleanliness of the filter 26, including but not limited to optical sensors, flow rate sensors, magnetic sensors, distance sensors, mechanical switches, temperature sensors, combinations thereof, and/or other suitable sensors as desired. However, in other embodiments, the means or devices may include sensing current drawn by the motor of pump 22. Other techniques and/or devices may be used as desired.

As mentioned, the APC 10 may include a controller (e.g., processing and control electronics). The APC 10 also may include at least one orientation sensor 39 (see FIG. 2), such as any or all of an accelerometer, a compass, a gyroscope, or a tilt sensor. To facilitate its presentation at waterline WL, the APC 10 may be programmed to locate and climb a generally vertical wall W of the pool P. Such location and climbing may, but need not, occur upon command of a user. As a non-limiting example, a user may engage a button on a control box wired to the APC 10 and/or on an application running on a user's device, and such engagement may provide a wired or wireless signal to the APC 10, which may cause the APC 10 to locate a wall and start climbing. Optionally, the user may provide a desired wall of the pool P for the APC 10 to climb, and the APC 10 may locate the desired wall using its orientation sensor (or otherwise) and subsequently climb the desired wall. Additionally or alternatively, location and climbing of a wall may occur automatically and/or otherwise be determined by the APC 10. As a non-limiting example, when the filter 26 is sensed to be full or otherwise need attention, the APC 10 may automatically orient itself relative to a wall and climb the wall W.

Any or all of the pump 22, drive or other motors, and/or buoyancy of the APC 10 may be employed to retain the APC 10 in position at the waterline WL of the pool P. Doing so allows a user an opportunity to grasp the filter 26 (e.g., via the handle 29) and remove it from the body 14 as illustrated in FIG. 2. The APC 10 may be configured so that it can retain its position at the waterline WL regardless of whether the filter 26 is installed in, or removed from, the body 14. In certain embodiments, the APC 10 may maintain its position at the waterline WL of the pool P such that the front end 38 is presented above the waterline WL as illustrated in FIGS. 1 and 2. In various embodiments, the APC 10 may maintain its position at the waterline WL of the pool P such that the debris filter 26 (and/or at least a portion of the debris filter 26, such as but not limited to the handle 29) is presented above the waterline WL as illustrated in FIGS. 1 and 2. In such embodiments, a user on the deck D may be able to remove the debris filter 26 from the body 24 of the APC 10 and/or install the debris filter 26 into the body 14 of the APC 10 without contacting water in the swimming pool P in which the APC 10 is operating.

As mentioned, the APC 10 may include means or devices for determining when the filter 26 has been cleaned and/or re-installed in the body 14. As an example, the APC 10 may sense current drawn by the motor of the pump 22 when the APC 10 is present at waterline WL. Based on the current drawn by the pump 22, the APC 10 may determine that the filter is not present (e.g., if a lower current is drawn) or present (e.g., if a higher current is drawn). The APC 20 additionally or alternatively may determine a cleanliness of the filter 26 based on the current drawn (e.g., a lower current may indicate that the filter 26 is cleaner and a higher current may indicate that the filter 26 is dirtier or clogged). Upon determining that the filter 26 has been re-installed (e.g., based on a detected increase in current drawn by the pump 22), the APC 10 may automatically perform one or more actions. As a non-limiting example, the APC 10 may be programmed to climb down wall W to resume cleaning a floor of the pool P upon determining that the filter 26 has been re-installed.

If the APC 10 uses one or more on-board batteries for operation, the batteries too may be removed and re-installed in manners similar to those described for removing and installing filter 26. As a non-limiting example, on-board batteries may be provided at the front end 38 and selectively removed from and/or re-installed on the APC 10 using techniques and features similar to those discussed above. Nothing associated with the invention, moreover, is intended to prevent a user from removing the APC 10 from the pool P when desired, either to clean the filter 26 or for another reason.

Exemplary concepts or combinations of features of the invention may include:
A. An APC configured to identify and climb a particular wall of a swimming pool to the waterline of the pool in order to facilitate removal of a debris filter of the APC.
B. The APC according to statement A, wherein the APC is configured to identify the particular wall of the swimming pool based on user input.
C. The APC according to statement A or B, wherein the user input is received wirelessly by the APC.
D. The APC according to any one of statements A-C, wherein the APC further comprises an orientation sensor, and wherein the APC is configured to identify the particular wall based on information detected by the orientation sensor.
E. The APC according to any one of statements A-D, wherein the APC is configured to climb to the waterline of the swimming pool and present a debris filter of the APC above the waterline.
F. The APC according to any one of statements A-E, wherein the debris filter is on a front end of the APC.
G. An APC configured to maintain its position at a waterline of a swimming pool in both a first condition, when a debris filter is installed in a body of the APC, and in a second condition, when the debris filter is removed from the body of the APC.
H. The APC according to statement G, wherein the APC is configured to present the debris filter above the waterline in the first condition.
I. The APC according to statement G or H, wherein the APC is configured to control a pump or motor of the APC to maintain its position at the waterline.
J. The APC according to any one of statements G-H, wherein the debris filter is accessed on a front of the body of the APC.
K. An APC configured so that a user can remove a debris filter from a body of the APC and/or install the debris filter into the body of the APC without contacting water in the swimming pool in which the APC is operating.
L. The APC according to statement K, wherein the APC is configured to present a front end of the body of the APC above the water line, wherein the debris filter is on the front end.
M. The APC according to statement K or L, wherein the APC is configured to maintain its position at a waterline of a swimming pool in both a first condition, when a debris filter is installed in a body of the APC, and in a second condition, when the debris filter is removed from the body of the APC.
N. An APC configured to detect whether a debris filter has been installed into a body of the APC.
O. The APC according to statement N, wherein the debris filter is on a front end of the body of the APC.
P. The APC according to statement N or O, wherein the APC comprises a sensor configured to detect whether the debris filter has been installed into the body of the APC.
Q. The APC according to any one of statements N-P, wherein the APC is configured to detect whether the debris filter has been installed into the body of the APC based on a current drawn by a pump of the APC.
R. The APC according to any one of statements N-Q, wherein the APC is configured to perform a cleaning action based on a detection that the debris filter has been installed into the body of the APC.
S. The APC according to any one of statements N-R, wherein the debris filter is installed on a front end of the APC.
T. An APC comprising means for removably retaining a debris filter in position within a body of the APC.
U. The APC according to statement T, wherein the means comprise a latch, a magnet assembly, or an underpressurization of the debris filter.
V. The APC according to statement T or U, wherein the debris filter is on a front end of the APC.
W. An APC comprising means for ejecting a debris filter from a body of the APC.
X. The APC according to statement W, wherein the means comprise a spring or repulsive magnet.
Y. The APC according to statement W or X, wherein the debris filter is on a front end of the APC, and wherein the means eject the debris filter from the front end.
Z. An APC including body having a front end and a debris filter at the front end and at least partially within the body, wherein the debris filter further comprises a handle extending from the body, and wherein the APC further comprises means for removably retaining a debris filter in position within a body of the APC.
AA. The APC according to statement Z, wherein the means are configured to retain the debris filter such that the handle of the debris filter functions as a lifting handle of the APC.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. An automatic swimming pool cleaner (“APC”) configured to identify a particular wall of a swimming pool and climb the identified wall to a waterline of the swimming pool in order to facilitate removal of a debris filter of the APC.

2. The APC of claim 1, wherein the APC is configured to identify the particular wall of the swimming pool based on user input.

3. The APC of claim 2, wherein the user input is received wirelessly by the APC.

4. The APC of claim 1, wherein the APC further comprises an orientation sensor, and wherein the APC is configured to identify the particular wall based on information detected by the orientation sensor.

5. The APC of claim 1, wherein the APC is configured to climb to the waterline of the swimming pool and present a debris filter of the APC above the waterline.

6. The APC of claim 1, wherein the debris filter is on a front end of the APC.

7. An automatic swimming pool cleaner (“APC”) configured to maintain its position at a waterline of a swimming pool in both a first condition, when a debris filter is installed in a body of the APC, and in a second condition, when the debris filter is removed from the body of the APC.

8. The APC of claim 7, wherein the APC is configured to present the debris filter above the waterline in the first condition.

9. The APC of claim 7, wherein the APC is configured to control a pump or motor of the APC to maintain its position at the waterline.

10. The APC of claim 7, wherein the debris filter is accessed on a front of the body of the APC.

11. An automatic swimming pool cleaner (“APC”) configured so that a user can remove a debris filter from a body of the APC and/or install the debris filter into the body of the APC without contacting water in the swimming pool in which the APC is operating.

12. The APC of claim 11, wherein the APC is configured to present a front end of the body of the APC above the water line, wherein the debris filter is on the front end.

13. The APC of claim 11, wherein the APC is configured to maintain its position at a waterline of a swimming pool in both a first condition, when a debris filter is installed in a body of the APC, and in a second condition, when the debris filter is removed from the body of the APC.

14. An automatic swimming pool cleaner (“APC”) configured to detect whether a debris filter has been installed into a body of the APC.

15. The APC of claim 14, wherein the debris filter is on a front end of the body of the APC.

16. The APC of claim 14, wherein the APC comprises a sensor configured to detect whether the debris filter has been installed into the body of the APC.

17. The APC of claim 14, wherein the APC is configured to detect whether the debris filter has been installed into the body of the APC based on a current drawn by a pump of the APC.

18. The APC of claim 14, wherein the APC is configured to perform a cleaning action based on a detection that the debris filter has been installed into the body of the APC.

19. The APC of claim 14, wherein the debris filter is installed on a front end of the APC.

20. An automatic swimming pool cleaner (“APC”) comprising means for removably retaining a debris filter in position within a body of the APC.

21. The APC of claim 20, wherein the means comprise a latch, a magnet assembly, or an underpressurization of the debris filter.

22. The APC of claim 20, wherein the debris filter is on a front end of the APC.

23. An automatic swimming pool cleaner (“APC”) comprising means for ejecting a debris filter from a body of the APC.

24. The APC of claim 23, wherein the means comprise a spring or a repulsive magnet.

25. The APC of claim 23, wherein the debris filter is on a front end of the APC, and wherein the means is configured to eject the debris filter from the front end.

26. An automatic swimming pool cleaner (“APC”) including a body having a front end and a debris filter at the front end and at least partially within the body, wherein the debris filter further comprises a handle extending from the body, and wherein the APC further comprises means for removably retaining the debris filter in position within the body of the APC.

27. The APC of claim 26, wherein the means are configured to retain the debris filter such that the handle of the debris filter functions as a lifting handle of the APC.
